(19) United States
(12) Patent Application Publication
(10) Pub. No.: US 2021/0122330 A1
(43) Pub. Date: Apr. 29, 2021

(54) VEHICLE AND METHOD OF CONTROLLING THE SAME

(71) Applicants: HYUNDAI MOTOR COMPANY, Seoul (KR); KIA MOTORS CORPORATION, Seoul (KR)

(72) Inventor: Kijun Sung, Yongin-si (KR)

(73) Assignees: HYUNDAI MOTOR COMPANY, Seoul (KR); KIA MOTORS CORPORATION, Seoul (KR)

(21) Appl. No.: 16/919,938

(22) Filed: Jul. 2, 2020

(30) Foreign Application Priority Data
Oct. 29, 2019 (KR) 10-2019-0135298

(51) Int. Cl. B60R 25/01; B60R 25/33; B60R 25/31; B60R 25/24; B60R 25/34; B60R 25/10; B60R 25/30

(52) U.S. Cl. CPC B60R 25/01; B60R 25/33; B60R 25/31; B60R 25/305; B60R 25/34; B60R 25/10; B60R 25/24

(57) ABSTRACT

A vehicle includes: a sensor configured to detect position information of the vehicle or a surrounding environment of the vehicle; a communicator configured to transmit or receive user information or the position information of the vehicle to or from a user terminal; and a controller. The controller is configured to determine whether the vehicle is positioned in a security vulnerable area based on the position information of the vehicle or a result of the detection and to control a locking device to unlock a door of the vehicle based on a result of the determination and the user information.

### CROSS-REFERENCE TO RELATED APPLICATION

This application is based on and claims priority under 35 U.S.C. § 119 to Korean Patent Application No. 10-2019-0135298, filed on Oct. 29, 2019 in the Korean Intellectual Property Office, the disclosure of which is incorporated herein by reference.

### BACKGROUND

### 1. Field

The disclosed embodiments relate to a vehicle and a method of controlling the same, and more specifically, to a vehicle for protecting a driver in a security vulnerable area and a method of controlling the same.

### 2. Description of the Related Art

In recent years, the number of crimes aimed at users who ride in a vehicle in a parking lot is increasing.

There is a safety unlock technology for removing the above described issues. However, the safety unlock technology is configured in a way to control only a locking device of a driver's door and has difficulty in detecting a criminal who approaches other doors except for the driver's door.

In addition, the conventional safety unlock technology is configured to be set only in a user setting mode, and thus has inconvenience in turning on or turning off the function. Users have difficulty in understanding the safety unlock technology.

### SUMMARY

Therefore, it is an object of the disclosure to provide a vehicle for determining whether the vehicle is present in a security vulnerable area based on various factors, such as surrounding environment information, user information, or position information of the vehicle, and for controlling a locking device of the vehicle based on a result of the determination. It is another object of the disclosure to provide a method of controlling the same.

Additional aspects of the disclosure are set forth in part in the following description and in part should be apparent from the description or may be learned by practice of the disclosure.

Therefore, it is an aspect of the disclosure to provide a vehicle including: a sensor configured to detect position information of the vehicle or a surrounding environment of the vehicle; a communicator configured to transmit or receive user information or the position information of the vehicle to or from a user terminal; and a controller. The controller is configured to determine whether the vehicle is positioned in a security vulnerable area based on the position information of the vehicle or a result of the detection and to control a locking device to unlock a door of the vehicle based on a result of the determination and the user information.

The controller may determine an approach position of a user and may control the locking device to unlock the door of the vehicle based on a result of the determination.

The controller may determine an approach position of a user and may determine an existence of an invader based on a result of the determination.

The controller may control the locking device to unlock the door of the vehicle based on the number of times that a door handle of the vehicle is pulled.

The controller may determine whether a door handle of the vehicle is pulled and may control the locking device to unlock the door of the vehicle after a preset period of time has elapsed based on a result of the determination.

The vehicle may further include a warner configured to generate a warning to surroundings. The controller may determine whether a user is exposed to a danger and may controls the warner to generate the warning to the surroundings of the vehicle based on a result of the determination.

The controller may determine whether a distance between the user terminal and the vehicle is greater than or equal to a preset distance and may generate a warning based on a result of the determination.

The communicator may transmit a rescue signal to the outside of the vehicle. The controller may determine whether the user terminal approaches a range within a preset distance from the vehicle within a preset time and may control the communicator to transmit the rescue signal based on a result of the determination.

The vehicle may further include an imager configured to capture an image of the surrounding environment or an inside of the vehicle. The controller may control the imager to capture the image of the surrounding environment or the inside of the vehicle based on whether the rescue signal is transmitted.

The controller may learn a traveling pattern, form data from a security vulnerable area based on a result of the learning and may determine whether the vehicle is positioned in the security vulnerable area based on the data.

It is another aspect of the disclosure to provide a method of controlling a vehicle. The method includes: detecting position information of the vehicle or a surrounding environment of the vehicle; transmitting or receiving user information or the position information of the vehicle to or from a user terminal; determining whether the vehicle is positioned in a security vulnerable area based on the position information of the vehicle or a result of the detection; and controlling a locking device to unlock a door of the vehicle based on a result of the determination and the user information.

The controlling may include determining an approach position of a user and controlling the locking device to unlock the door of the vehicle based on a result of the determination.

The controlling may include determining an approach position of a user and determining an existence of an invader based on a result of the determination.

The controlling may include controlling the locking device to unlock the door of the vehicle based on the number of times that a door handle of the vehicle is pulled.

The controlling may include determining whether a door handle of the vehicle is pulled and controlling the locking device to unlock the door of the vehicle after a preset period of time has elapsed based on a result of the determination.

The method may further include generating a warning to surroundings of the vehicle. The controlling may include determining whether a user is exposed to a danger and generating the warning to the surroundings of the vehicle based on a result of the determination.

The controlling may include determining whether a distance between the user terminal and the vehicle is greater than or equal to a preset distance and generating a warning based on a result of the determination.

The method may further include transmitting a rescue signal to the outside of the vehicle. The controlling may include determining whether the user terminal approaches a range within a preset distance from the vehicle within a preset time and transmitting the rescue signal based on a result of the determination.

The method may further include capturing an image of the surrounding environment or an inside of the vehicle. The controlling may include capturing the image of the surrounding environment or the inside of the vehicle based on whether the rescue signal is transmitted.

The controlling may include learning a traveling pattern, forming data from the security vulnerable area based on a result of the learning, and determining whether the vehicle is positioned in the security vulnerable area based on the data.

### BRIEF DESCRIPTION OF THE DRAWINGS

These and/or other aspects of the disclosure should become apparent and more readily appreciated from the following description of the embodiments, taken in conjunction with the accompanying drawings of which:

FIG. 1 is a view illustrating a vehicle according to a disclosed aspect;

FIG. 2 is a control block diagram illustrating a vehicle according to a disclosed aspect;

FIG. 3 is a flowchart showing a door unlocking process according to a disclosed aspect;

FIG. 4 is a flowchart showing a process of cancelling an alert mode of a vehicle according to a disclosed an aspect;

FIG. 5 is a view illustrating a process of warning the surroundings of a vehicle or transmitting a rescue signal to the outside according to a disclosed aspect;

FIG. 6 is a view illustrating a process of learning a security vulnerable area by a vehicle according to a disclosed aspect; and

FIG. 7 is a flowchart showing a process of warning the surroundings of a vehicle according to a disclosed aspect.

### DETAILED DESCRIPTION

Identical numerals refer to identical or equivalent elements throughout the specification. Not all elements of embodiments of the present disclosure are described, and descriptions of the elements commonly known in the art or duplicated with those in the embodiments have been omitted. The terms as used throughout the specification, such as “˜ part”, “˜ module”, “˜ member”, “˜ block”, etc., may be implemented in software and/or hardware, and a plurality of “˜ parts”, “˜ modules”, “˜ members”, or “˜ blocks” may be implemented in a single element, or a single “˜ part”, “˜ module”, “˜ member”, or “˜ block” may include a plurality of elements.

It should be further understood that the term “connect” or its derivatives refer both to direct and indirect connection, and the indirect connection includes a connection over a wireless communication network.

It should be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof, unless the context clearly indicates otherwise. When a component, device, or element of the present disclosure is described as having a purpose or performing an operation, function, or the like, the component, device, or element should be considered herein as being “configured to” meet that purpose or to perform that operation, function, or the like.

Although the terms “first,” “second,” “A,” “B,” etc. may be used to describe various components, the terms do not limit the corresponding components, but are used only for the purpose of distinguishing one component from another component.

As used herein, the singular forms “a,” “an,” and “the” are intended to include the plural forms as well, unless the context clearly indicates otherwise.

Reference numerals used for method steps are just used for convenience of explanation, but not to limit an order of the steps. Thus, unless the context clearly dictates otherwise, the written order may be practiced otherwise.

Hereinafter, the operating principles and embodiments of the present disclosure are described with reference to the accompanying drawings.

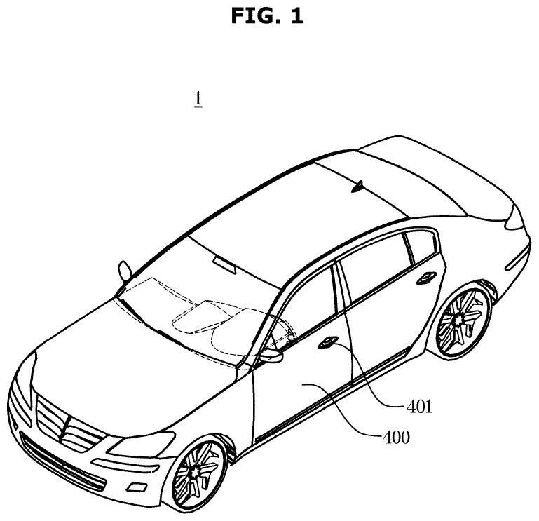

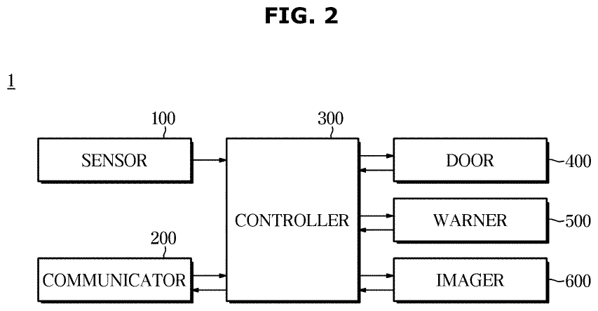

FIGS. 1 and 2 are views illustrating a vehicle according to a disclosed aspect.

Referring to FIGS. 1 and 2, the vehicle 1 according to the disclosed embodiment may include a sensor 100, a communicator 200, a controller 300, a door 400, a warner 500, or an imager 600. The door 400 includes a door handle 401, a door switch, or a locking device.

The sensor 100 according to the disclosed embodiment detects position information of the vehicle 1 or a surrounding environment of the vehicle 1.

In detail, the sensor 100 may include a global positioning system (GPS) sensor for detecting position information of the vehicle 1.

In addition, the sensor 100 may include an illumination sensor, a camera, a lidar sensor, or a radar sensor to detect the surrounding environment of the vehicle 1.

However, the sensor and the camera included in the sensor 100 are not limited thereto. The sensor 100 may instead or further include another configuration capable of detecting the position information of the vehicle 1 and another configuration capable of detecting the surrounding environment of the vehicle 1.

In addition, the vehicle 1 according to the disclosed embodiment may include a storage (not shown) for receiving a detection result from the sensor 100 or receiving place information of a place in which the vehicle 1 is positioned from an external server, and for storing the received detection result or the received place information therein.

The storage (not shown) may include a nonvolatile memory device, such as a cache, a read only memory (ROM), a programmable ROM (PROM), an erasable programmable ROM (EPROM), an electrically erasable programmable ROM (EEPROM), and a flash memory, a volatile memory device, such as a random access memory (RAM), or other storage media, such as a hard disk drive (HDD), a CD-ROM, and the like, but the implementation of the storage is not limited thereto. The storage may be a memory implemented as a chip separated from the processor, which is described below in connection with the controller 300 or may be implemented as a single chip integrated with the processor.

The communicator 200 according to the disclosed embodiment may transmit or receive preset user information or position information to or from the vehicle 1.

In this embodiment, the user terminal may be implemented as a computer or a portable terminal capable of connecting to the vehicle 1 through a network. In this embodiment, the computer may include, for example, a notebook computer, a desktop computer, a laptop PC, a tablet PC, a slate PC, and the like, each of which is equipped with a WEB Browser. The portable terminal is a wireless communication mobility device. The portable terminal may include: all types of handheld based wireless communication devices, such as a personal communication system (PCS), a global system for mobile communications (GSM), a personal digital cellular (PDC), a personal handy phone system (PHS), a personal digital assistant (PDA), an international mobile telecommunication (IMT)-2000, a code division multiple access (CDMA)-2000, a w-code division multiple access (W-CDMA), a wireless broadband internet (WiBro) terminal, a smart Phone, and the like. The portable terminal may also include wearable devices, such as a watch, a ring, a bracelet, an ankle bracelet, a necklace, glasses, a contact lens, or a head-mounted-device (HMD).

In addition, the communicator 200 according to the disclosed embodiment may transmit a rescue signal to the outside.

In detail, the communicator 200 may transmit a rescue signal (an emergency call) to the outside when an alert mode of the vehicle 1 is not cancelled within a preset reference time, which is described below.

In addition, the communicator 200 may receive security information of a place in which the vehicle 1 is positioned from an external server and may transmit the received security information to the storage (not shown).

In detail, the security information may include information regarding a crime rate of a place in which the vehicle 1 is positioned, a crime history of the place, a floating population of the place, or whether the place is an area patrolled by a public institution.

In addition, the communicator 200 may include one or more components that enable communication with an external device, such as for example, at least one of a short-range communication module, a wired communication module, and a wireless communication module.

The short-range communication module may include various short-range communication modules that transmit and receive signals using a wireless communication network in a short range, such as a Bluetooth module, an infrared communication module, a radio frequency identification (RFID) communication module, a wireless local access network (WLAN) communication module, an NFC communication module, and a Zig bee communication module.

The wired communication module may include various wired communication modules, such as a controller area network (CAN) communication module, a local area network (LAN) module, a wide area network (WAN) module, or a value added network communication (VAN) module, and various cable communication modules, such as a universal serial bus (USB) module, a high definition multimedia interface (HDMI) module a digital visual interface (DVI) module, a recommended standard-232 (RS-232) module, a power line communication module, or a plain old telephone service (POTS) module.

The wireless communication module may include wireless communication modules supporting various wireless communication methods, such as a Wi-Fi module, a wireless broadband module (Wibro) module, a global system for mobile communication (GSM) module, a code division multiple access (CDMA) module, a wideband code division multiple access (WCDMA) module, a universal mobile telecommunications system (UMTS) module, a time division multiple access (TDMA) module, a long term evolution (LTE) module, and the like.

The wireless communication module may include a wireless communication interface including an antenna and a transmitter for transmitting signals. In addition, the wireless communication module may further include a signal converting module for converting a digital control signal output from the controller 300 through the wireless communication interface into an analog type wireless signal under the control of the controller 300.

The wireless communication module may include a wireless communication interface including an antenna and a receiver for receiving signals. In addition, the wireless communication module may further include a signal converting module for demodulating an analog type wireless signal received through the wireless communication interface into a digital control signal.

The controller 300 according to the disclosed embodiment may determine whether the vehicle 1 is positioned in a security vulnerable area based on the position information of the vehicle 1 or a result of the detection. The controller 300 may control a locking device to unlock the door 400 of the vehicle 1 based on a result of the determination and the user information.

In addition, the controller 300 according to the disclosed embodiment may determine an approach position of the user and may control the locking device to unlock the door 400 of the vehicle 1 based on a result of the determination. In addition, the controller 300 according to the disclosed embodiment may determine the approach position of the user and may determine a person, who is not registered in the user information, attempting to open the door of the vehicle 1 as an invader.

In addition, the controller 300 according to the disclosed embodiment may determine whether a user is exposed to a danger and may control the warner 500 to generate a warning to the surroundings of the vehicle 1 based on a result of the determination.

In addition, the controller 300 according to the disclosed embodiment may determine whether the user terminal approaches a range within a preset distance from the vehicle 1 in a preset time. The controller 300 may control the communicator 200 to transmit the rescue signal to the outside based on a result of the determination.

In addition, the controller 300 may include a memory (not shown) for storing data regarding an algorithm for controlling the operations of the components of the vehicle or a program that represents the algorithm. The controller 300 may include a processor (not shown) that performs the above described operations using the data stored in the memory. In this embodiment, the memory and the processor may be implemented as separate chips. Alternatively, the memory and the processor may be implemented as a single chip.

The door 400 according to the disclosed embodiment refers to a component provided on the vehicle 1, the component being configured to allow a person or an object to enter the vehicle 1 from the outside. The door 400 may include a door provided at the side of the vehicle 1, a window, and a trunk or sunroof provided at the rear or front of the vehicle 1. However, the door 400 is not limited thereto, and may include another configuration for physically connecting the inside and the outside of the vehicle 1.

In addition, the door 400 may include a door handle 401, a door switch (not shown), or a locking device (not shown).

The warner 500 according to the disclosed embodiment may warn the surrounding of the vehicle by generating sound or light.

In detail, the warner 500 may be a buzzer provided in the vehicle 1. In addition, the warner 500 may be a light provided in the vehicle 1. If it is determined that an intruder exists, the warner 500 may warn the surroundings by ringing the buzzer or flicking the light. However, the warning method of the warner 500 is not limited thereto and may further include another method as long as it can warn the intruder and secure the user's safety.

The imager 600 according to the disclosed embodiment may capture the image of the surrounding environment or the inside of the vehicle 1. The imager 600 may include a camera, a camera sensor, a radar, an infrared sensor, or a lidar sensor. However, the configuration of the imager 600 is not limited thereto and may include another configuration capable of imaging and detecting the inside or the outside of the vehicle 1.

In addition, the imager 600 may capture the image of the surrounding environment or the inside of the vehicle 1 if the vehicle 1 enters the alert mode or if image capturing is determined to be needed according to a user definition.

In this embodiment, the user terminal may recommend the user definition based on the user's age, gender or physical disability.

At least one component may be added or omitted according to the performances of the components of the vehicle 1 shown in FIGS. 1 and 2. In addition, the relative positions of the components may be changed according to the performance or structure of the system.

Meanwhile, the components shown in FIGS. 1 and 2 may refer to a software component and/or a hardware component, such as a Field Programmable Gate Array (FPGA) and an Application Specific Integrated Circuit (ASIC).

Hereinafter, a process of controlling the components of the vehicle 1 by the controller 300 is described in detail.

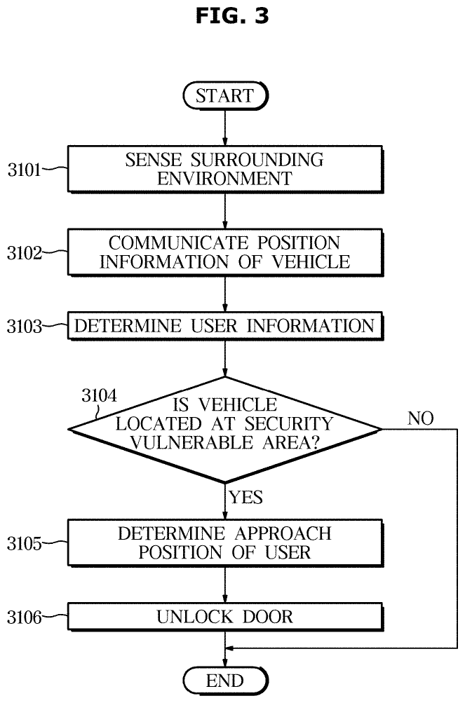

FIG. 3 is a flowchart showing an unlocking process of the door 400 according to a disclosed aspect.

Referring to FIG. 3, the sensor 100 detects a surrounding environment of the vehicle 1 and transmits a result of the detection to the controller 300 (3101).

In detail, the surrounding environment of the vehicle 1 may include the presence or absence of a person having a strange behavior around the vehicle 1, the illuminance around the vehicle 1, the approach position of a user approaching the vehicle 1, or the floating population around the vehicle 1. However, the surrounding environment information of the vehicle 1 is not limited thereto and may further include other information that may affect the safety of the user.

In addition, the sensor 100 may detect the position information of the vehicle 1, and transmit the detection result to the communicator 200 or the controller 300 (3102).

In detail, the position information of the vehicle 1 refers to place information of a place in which the vehicle 1 is positioned. The position information may include information regarding a crime rate of the place in which the vehicle 1 is positioned, a crime history of the place, a floating population of the place, or whether the place is an area patrolled by a public institution.

In addition, the controller 300 may determine user information (3103).

In detail, the user information may include information about a gender, age, physical disability, passenger information, or whether the user is accompanied by a child. However, the user information is not limited thereto and may further include other information regarding the safety of the user.

In addition, the user may input the user information to the user terminal, and the user terminal may transmit the input user information to the communicator 200 or the controller 300. The controller 300 may determine a security vulnerable area based on the received user information.

The controller 300 may determine whether the vehicle 1 is in the security vulnerable area based on the position information of the vehicle 1, the detection result of the sensor 100, or the user information (3104).

For example, the control 300 may determine that the vehicle is positioned in the security vulnerable area if the vehicle 1 is positioned in an area having a high crime rate, a floating population does not exist around the vehicle 1, and the user is determined to be a female as a result of determining the user information. However, the determination is merely one disclosed embodiment. The controller 300 may determine the security vulnerable area according to various criteria by combining the position information of the vehicle 1, the detection result of the detector 100, or the user information.

The controller 300, in response to determining that the vehicle 1 is positioned in the security vulnerable area, determines the approach position of the user approaching the vehicle (3105). However, the controller 300, in response to determining that the vehicle 1 is not positioned in the security vulnerable area, terminates the process of controlling the unlocking of the door 400.

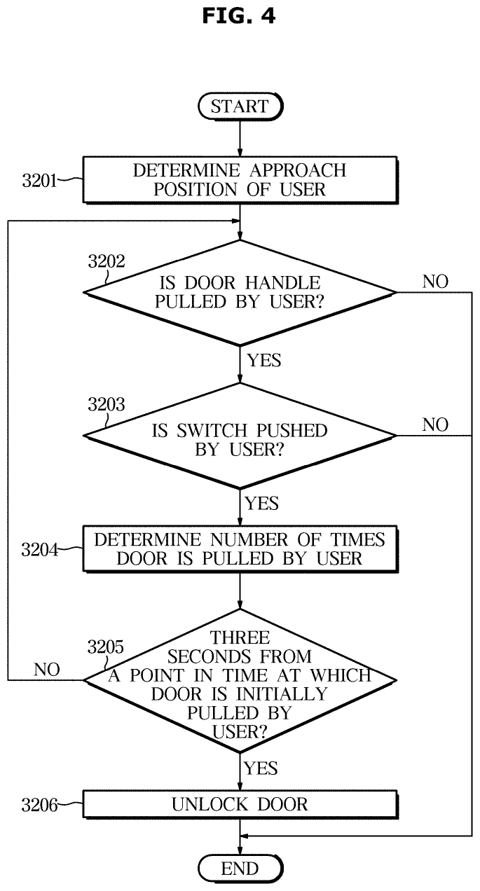

The controller 300 determines the approach position of the user and controls the locking device to open the door 400 adjacent to the user (3106). The process of unlocking the door 400 by the controller 300 is described in detail with reference to FIG. 4.

FIG. 4 is a flowchart showing a process of cancelling an alert mode of a vehicle according to a disclosed an aspect.

The alert mode refers to a setting in which the vehicle 1 does not immediately open the door 400 but open the door 400 only when a preset criterion is satisfied.

The controller 300 according to the disclosed embodiment determines the approach position of the user based on the detection result of the sensor 100 (3201).

The controller 300 determines whether the user has pulled the door handle of the door 400 or whether the user has pressed the door switch (3202 and 3203). If the controller 300 determines that the user has pulled the door handle of the door 400 or the user has pressed the door switch, the controller 300 enters the alert mode of the vehicle 1. However, if the controller 300 determines that the user has not pulled the door handle of the door 400 or the user has not pressed the door switch, the controller 300 terminates the control process without unlocking the door 400.

If the controller 300 determines that the user has pulled the door handle of the door 400 or the user has pressed the door switch, the controller 300 determines the number of times that the user has pulled the door 400 or the user has pressed the door switch (3204).

In detail, the controller 300 according to the disclosed embodiment determines the number of times that the user has pulled the door handle 401 of the vehicle 1. If the controller 300 determines as a result of the determination that the user has pulled the door handle 401 more than a preset reference number of times, the controller 300 may control the locking device to unlock all the doors 400 of the vehicle 1.

According to the disclosed embodiment, when the user pulls the door handle 401 once, the controller 300 may enter the alert mode and control the locking device to open the door 400 adjacent to the user. When the user pulls the door handle 401 twice, the controller 300 may control the locking device to unlock all the doors 400 of the vehicle 1. However, the number of times that the user pulls the door handle 401 is not limited thereto and may vary according to the user definition.

In addition, the controller 400 may determine whether the user pulls the door handle 401 of the vehicle 1 and may control the locking device to unlock the door 400 of the vehicle when a preset amount of time has elapsed based on a result of the determination (3205).

According to the disclosed embodiment, when a preset time of 3 seconds has elapsed from the point in time at which the user initially pulls the door handle 401, the controller 300 may control the locking device to unlock the door 400 (3206). However, the preset time is not limited thereto and may vary according to the user definition.

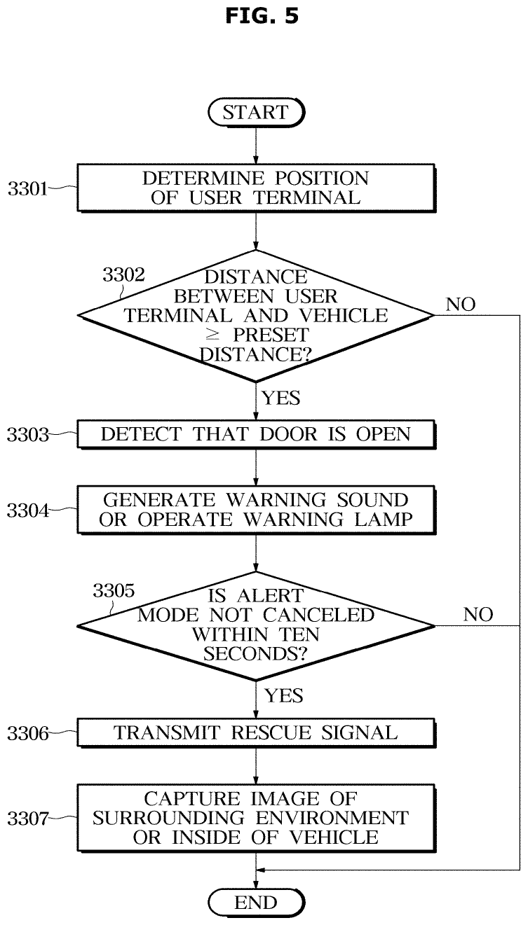

FIG. 5 is a view illustrating a process of warning the surroundings of a vehicle or transmitting a rescue signal to the outside according to a disclosed aspect.

According to the disclosed embodiment, the controller 300 may determine the position of the user by detecting the position of the user terminal (3301).

For example, the controller 300 may determine that the position of the user is 10 m away from the vehicle 1 if the controller 300 detects that the position of the user terminal is 10 m away from the vehicle 1.

The controller 300 according to the disclosed embodiment determines whether the distance between the user terminal and the vehicle 1 is greater than or equal to a preset distance (3302).

In this embodiment, the preset distance may be set based on information of the walking speed of the user, the gender of the user, the height information of the user, or the like, and may be variously set according to the user definition.

The controller 300, in response to determining that the distance between the user terminal and the vehicle 1 is greater than or equal to the preset distance, detects whether the door 400 is open or there is an attempt to open the door 400 (3303). However, the controller 300, in response to determining that the distance between the user terminal and the vehicle 1 is less than the preset distance, turns off the alert mode and terminates the control process.

The controller 300, in response to determining that the door 400 is open or there is an attempt to open the door 400, controls the warner 500 to generate a warning sound or operate a warning lamp (3304).

According to the disclosed embodiment, the warner 500 may warn the surroundings of the vehicle by a method of intermittently generating a warning sound or a method of periodically operating a warning lamp. However, the method of warning the surroundings, by the warner 500, is not limited thereto and may further include another method, as long as it can warn an intruder and secure the user's safety.

The controller 300, in response to determining that the user is not within the preset distance and that the door 400 is open, determines whether the user approaches a range within the preset distance from the vehicle 1 in a preset time (3305).

The controller 300, in response to determining that the user has not approached the vehicle 1 in a preset time, may control the communicator 200 to transmit a rescue signal (an emergency call) to the outside (3306).

For example, if the preset time is 10 seconds and the user does not enter the range within the preset distance within 10 seconds, the controller 300 may control the communicator 200 to transmit a rescue signal (an emergency call) to the outside (3306). However, if the controller 300 determines that the user has approached the vehicle 1 within the preset time, the controller 300 cancels the alert mode and terminates the control process.

In this embodiment, the preset time may be set based on information regarding the pace of the user, the gender of the user, the height information of the user, or the like, and may be variously set according to the user definition.

In addition, the outside or the outside of the vehicle, as used herein, that receives the rescue signal may include a service center for the vehicle 1, a public institution, a safety center, or a security center. However, the outside that receives the rescue signal is not limited thereto and may include other facilities, parties, or contacts of people around the user capable of protecting the safety of the user.

According to the disclosed embodiment, the controller 300, if the rescue signal (an emergency call) is transmitted, may control the imager 600 to capture an image of the surrounding environment of the vehicle 1 or the inside of the vehicle 1 (3307). The image captured by the imager 600 according to the disclosed embodiment has an effect of preserving the evidence of an accident scene of the vehicle 1.

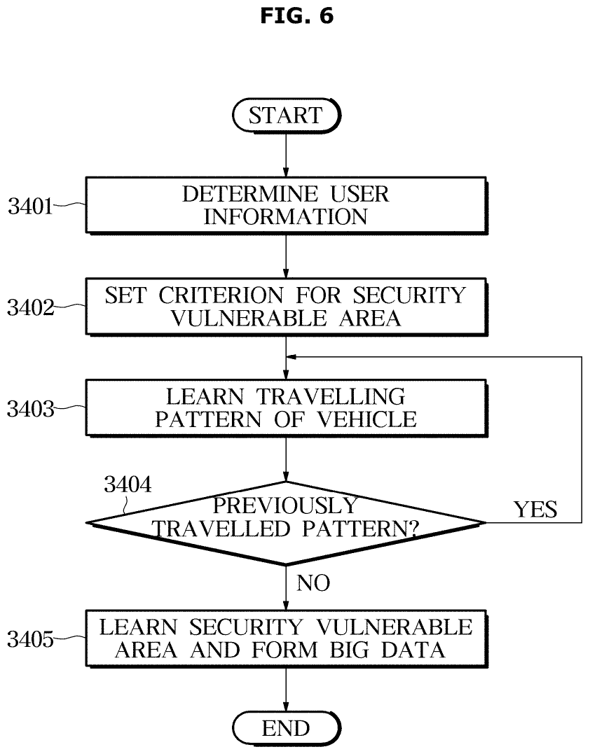

FIG. 6 is a view illustrating a process of learning a security vulnerable area by a vehicle according to a disclosed aspect.

In detail, the controller 300 determines user information input to the user terminal (3401).

As described above, the user information may include information about a gender, age, physical disability, passenger information, or whether the user is accompanied by a child. However, the user information is not limited thereto and may further include other information regarding the safety of the user.

The controller 300 may set a criterion for a security vulnerable area based on the input user information (3402).

For example, the controller 300 may set an area having a large number of crimes against women as the criterion for the security vulnerable area if the user is determined to be a female, have a small body, and have no passenger information as a result of determining the user information.

As another example, the controller 300 may set an area having a high frequency of violent crimes as the criterion for the security vulnerable area if the user is determined to be a male, have a bulky body, and have passenger information as a result of determining the user information.

However, the criterion for the security vulnerable area described above is merely one example and may be variously set based on the user information or user definition.

The controller 300 may learn a travelling pattern of the vehicle 1 (3403).

In detail, the controller 300 may learn security information with respect to a place where the vehicle 1 frequently travels.

For example, if the controller 300 determines, as a result of learning the travelling pattern of the vehicle 1, that the vehicle 1 frequently visits a large mart, the controller 300 may be configured to learn a travelling pattern of the vehicle 1 based on the type of crimes that have recently occurred in a large mart parking lot.

However, such a learning is merely one disclosed embodiment. The controller 300 may learn the travelling pattern with respect to another type of destination of the vehicle 1.

The controller 300 keeps learning the travelling pattern of the vehicle 1 if the controller 300 determines, as a result of learning the travelling pattern, that the travelling pattern is a pattern that the vehicle 1 has previously travelled. However, if the controller 300 determines that the travelling pattern is a new travelling pattern, the controller 300 may learn a security vulnerable area, store a result of the learning in the storage (not shown), and form data, i.e., generate a substantial database, from the result of the learning (3404 and 3405).

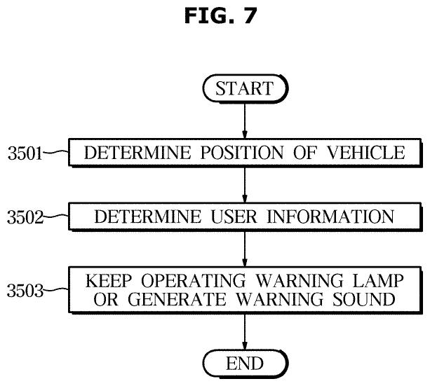

FIG. 7 is a flowchart showing a process of warning the surroundings of a vehicle when the vehicle is not in an alert mode according to a disclosed aspect.

In detail, the controller 300 determines the position of the vehicle 1 and determines the user information (3501 and 3502).

The controller 300 may control the warner 500 to warn the surroundings according the user setting. The controller 300 may do so even if the controller determines, as a result of the determination, that the vehicle 1 is not positioned in the security vulnerable area and the vehicle 1 has not entered the alert mode (3503). By warning the surroundings of the vehicle 1, even if the vehicle 1 is not determined to be in the alert mode, the disclosed embodiment has an effect of preventing accidental crimes in advance.

As should be apparent from the above, the disclosed embodiments can simplify the setting of the vehicle safety unlock function and can enable the safety unlock technology to be easily used by a user.

In addition, the disclosed embodiments can stabilize the vehicle safety unlock function, determine the safety vulnerable area based on elaborated criterion, and improve the safety of the user.

Meanwhile, the disclosed embodiments, including the controller, may be embodied in the form of a recording medium storing instructions executable by a computer. The instructions may be stored in the form of program code and, when executed by a processor, may generate a program module to perform the operations of the disclosed embodiments. The recording medium may be embodied as a computer-readable recording medium.

The computer-readable recording medium includes all kinds of recording media in which instructions decodable by a computer are stored, for example, a Read Only Memory (ROM), a Random-Access Memory (RAM), a magnetic tape, a magnetic disk, a flash memory, an optical data storage device, and the like.

Although specific embodiments of the present disclosure have been described for illustrative purposes, those having ordinary skill in the art should appreciate that various modifications, additions and substitutions are possible, without departing from the scope and spirit of the present disclosure. Therefore, the specific embodiments of the present disclosure have not been described for limiting purposes.

What is claimed is:

1. A vehicle comprising:
a sensor configured to detect position information of the vehicle or a surrounding environment of the vehicle;
a communicator configured to transmit or receive user information or the position information of the vehicle to or from a user terminal; and
a controller configured to determine whether the vehicle is positioned in a security vulnerable area based on the position information of the vehicle or a result of the detection and to control a locking device to unlock a door of the vehicle based on a result of the determination and the user information.

2. The vehicle of claim 1, wherein the controller determines an approach position of a user and controls the locking device to unlock the door of the vehicle based on a result of the determination.

3. The vehicle of claim 2, wherein the controller determines the approach position of the user and determines an existence of an invader based on a result of the determination.

4. The vehicle of claim 1, wherein the controller controls the locking device to unlock the door of the vehicle based on the number of times that a door handle of the vehicle is pulled.

5. The vehicle of claim 1, wherein the controller determines whether a door handle of the vehicle is pulled and controls the locking device to unlock the door of the vehicle after a preset period of time has elapsed based on a result of the determination.

6. The vehicle of claim 1, further comprising a warner configured to generate a warning to surroundings,
wherein the controller determines whether a user is exposed to a danger and controls the warner to generate the warning to the surroundings of the vehicle based on a result of the determination.

7. The vehicle of claim 6, wherein the controller determines whether a distance between the user terminal and the vehicle is greater than or equal to a preset distance and generates a warning based on a result of the determination.

8. The vehicle of claim 1, wherein the communicator transmits a rescue signal to outside the vehicle,
wherein the controller determines whether the user terminal approaches a range within a preset distance from the vehicle within a preset time and controls the communicator to transmit the rescue signal based on a result of the determination.

9. The vehicle of claim 8, further comprising an imager configured to capture an image of the surrounding environment or an inside of the vehicle,
wherein the controller controls the imager to capture the image of the surrounding environment or the inside of the vehicle based on whether the rescue signal is transmitted.

10. The vehicle of claim 1, wherein the controller learns a traveling pattern, forms data from the security vulnerable area based on a result of the learning, and determines whether the vehicle is positioned in the security vulnerable area based on the data.

11. A method of controlling a vehicle, the method comprising:
detecting position information of the vehicle or a surrounding environment of the vehicle;
transmitting or receiving user information or the position information of the vehicle to or from a user terminal;
determining whether the vehicle is positioned in a security vulnerable area based on the position information of the vehicle or a result of the detection; and
controlling a locking device to unlock a door of the vehicle based on a result of the determination and the user information.

12. The method of claim 11, wherein the controlling comprises determining an approach position of a user and controlling the locking device to unlock the door of the vehicle based on a result of the determination.

13. The method of claim 12, wherein the controlling comprises determining the approach position of the user and determining an existence of an invader based on a result of the determination.

14. The method of claim 11, wherein the controlling comprises controlling the locking device to unlock the door of the vehicle based on the number of times that a door handle of the vehicle is pulled.

15. The method of claim 11, wherein the controlling comprises:
determining whether a door handle of the vehicle is pulled; and
controlling the locking device to unlock the door of the vehicle after a preset period of time has elapsed based on a result of the determination.

16. The method of claim 11, further comprising generating a warning to the surrounding environment of the vehicle,
wherein the controlling comprises determining whether a user is exposed to a danger and generating the warning to the surrounding environment of the vehicle based on a result of the determination.

17. The method of claim 16, wherein the controlling comprises determining whether a distance between the user terminal and the vehicle is greater than or equal to a preset distance and generating a warning based on a result of the determination.

18. The method of claim 11, further comprising transmitting a rescue signal to outside the vehicle,
wherein the controlling comprises determining whether the user terminal approaches a range within a preset distance from the vehicle within a preset time and transmitting the rescue signal based on a result of the determination.

19. The method of claim 18, further comprising capturing an image of the surrounding environment or an inside of the vehicle,
wherein the controlling comprises capturing the image of the surrounding environment or the inside of the vehicle based on whether the rescue signal is transmitted.

20. The method of claim 11, wherein the controlling comprises learning a traveling pattern, forming data from the security vulnerable area based on a result of the learning, and determining whether the vehicle is positioned in the security vulnerable area based on the data.
